(19) United States
(12) Patent Application Publication
(10) Pub. No.: US 2012/0242478 A1
(43) Pub. Date: Sep. 27, 2012

(54) DIGITAL ELECTRONIC SECOND IDENTITY FOR VEHICLE

(76) Inventor: Weng Onn Chen, Singapore (SG)

(21) Appl. No.: 13/513,196

(22) PCT Filed: Jun. 5, 2010
(86) PCT No.: PCT/SG2010/000178

§ 371 Date: Jun. 1, 2012

(30) Foreign Application Priority Data
Dec. 16, 2009 (SG) 200908388-2

(51) Int. Cl. B60Q 1/26

(52) U.S. Cl. 340/463

(57) ABSTRACT

A digital electronic second identity for a vehicle used to discourage criminal activities as it is displaying the vehicle registration plate in a more obvious and elevated position than the primary vehicle registration plate, making it easier for public to notice when the vehicle is involved in a process of criminal act. Moreover, it is also used to enhance safety in the operation of the vehicle as it is activated when the vehicle is accelerating, decelerating, colliding, or swerving.

### TECHNICAL FIELD

The present invention relates to a digital electronic second identity for vehicle, more particularly, to a sensor activated light-emitting diode (LED) display that indicates information pertaining to a vehicle registration plate for deterring crimes and enhancing safety operation of vehicle.

### BACKGROUND ART

Nowadays, more and more road users have become victims of road crime such as motorcycle robbery and hit and run. Road crime rate is ever increasing as no solutions have been drawn to address on such matter yet. In addition, vehicle is commonly employed by criminals as a tool for assisting in the process of criminal act or as a means for escaping from a crime scene. The type of crimes includes robbery and kidnapping as well.

Normally, a person who intends to perform a crime will make preparation for getting away by using some sort of vehicle, for instance car or motorcycle. The vehicle registration plate is modified by that person in order to avoid being identified as the traditional vehicle registration plate is easy to remove or change. The modification can be in the form of altering a whole or a part of the vehicle registration plate to mislead the public with wrong information. Also, bright lighting can be installed near to the vehicle registration plate to prevent the information from being seen or read by the public as their visibility is reduced. In addition, the lighting for illuminating the vehicle registration plate can be completely removed for the same purpose. Hence, law enforcers are confused and would have difficulty in tracking that person as the information relating to the vehicle registration plate is either inaccurate or cannot be read.

In another scenario, a person who already committed a crime such as hit and run or robbery would have sped off from the crime scene. The public would not have sufficient time to record the vehicle registration plate of the criminal, thus that criminal would have the chance to flee from the crime scene without being, identified. Furthermore, the standard vehicle registration plate is often small, relatively low to the ground, and hard to be been by others especially at the time of chaos.

Therefore it is an aim of this current invention to provide a solution to deter crime by presenting a digital electronic second identity which is activated upon detection of motion changes of a vehicle that is obvious to public. It is another aim of this present invention to provide a safety indication on the operation of a vehicle.

### SUMMARY OF THE PRESENT INVENTION

This present invention relates to a digital electronic second identity for a vehicle. It is used to discourage criminal activities as it is showing the vehicle registration plate in a more obvious and elevated position than the primary vehicle registration plate, making it easier for public to notice if the vehicle is involved in a process of criminal act. Moreover, it is also used to enhance safety in the operation of the vehicle as it is activated when the vehicle is accelerating, decelerating, colliding, or swerving.

In one embodiment of this present invention, the digital electronic second identity comprises a light-emitting diode (LED) display which is activated by a chipset upon receiving a signal generated by a sensor. The sensor is capable of detecting the acceleration and deceleration of the vehicle. As the LED display is also activated by deceleration, it doubles up as an alert brake light. Also, when a collision occurred between the vehicle and any other objects, the sensor will be able to detect the impact. Further, the sensor is able to detect an unstable swerving of the vehicle.

In another embodiment of this present invention, upon activation of the digital electronic secondary identity, the LED display will show the vehicle registration plate for a stipulated amount of time, alerting the public to take note on the vehicle.

In a further embodiment of this present invention, the LED display can be used on any part of the vehicle. Its light intensity is bright enough to be seen clearly during the day. The LED display is energy efficient as it consumes little energy to work.

In yet another embodiment of this present invention, the information pertaining to the vehicle registration plate is pre-programmed into a chipset of the digital electronic second identity by an authorized party. This prevents the identity manipulation of the vehicle as only an authorized party is allowed to supply, sell and program the chipset.

In yet a further embodiment of this present invention, this digital electronic second identity is powered by two battery sources. The primary battery source is a rechargeable battery that stores energy supplied by a solar panel. This can be particularly useful since the frequency of battery change can drastically be reduced, thus lowering environmental footprint. The secondary battery source is a non-rechargeable battery that supplies power to the digital electronic second identity when the primary battery source is depleted. In the presence of a vehicle battery such as a car battery, the digital electronic second identity is able to utilized said vehicle battery as power source. When the primary and secondary battery sources are running low, the digital electronic second identity will give out a warning through beeping sound. The warning will only cease when either the primary battery source is recharged or the secondary battery source is replaced with a new one.

In yet a further embodiment of this present invention, the digital electronic second identity is attached to the rear of the vehicle at an elevated level, for instance, to the rear windscreen of a car. In the case of a motorcycle, it is attached to the rear of the motorcyclist helmet, tail luggage box, or on the back of the rider's jacket.

In still yet another embodiment of this present invention, the digital electronic second identity can be utilized in harsh conditions as it is designed and built to withstand shock and vibration. Further, it is also designed and built to resist moisture as the casing has been sealed with an O-ring seal and has no case penetration.

### BRIEF DESCRIPTION OF THE DRAWINGS

A complete understanding of the present invention may be obtained by reference to the accompanying drawing, when considered in conjunction with the subsequent, detailed description in which:

FIG. 1 illustrates the complete assembly of the digital electronic second identity for vehicle; and

FIG. 2 illustrates the positions of the switch, primary battery source, secondary battery source, chipset, and sensor inside the control unit.

### DETAILED DESCRIPTION OF THE PRESENT INVENTION

While the invention is described herein by way of example using several embodiments and illustrative drawings, those skilled in the art will recognize that the invention is not limited to the embodiments of drawing or drawings described, and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Further, the words “a” or “an” mean “at least one” and the word “plurality” means one or more, unless otherwise mentioned.

In accordance with the present invention, there is disclosed a digital electronic second identity for vehicle used for deterring criminal activities. This is possible as the digital electronic second identity is showing information pertaining to a vehicle registration plate in a more obvious and elevated position than the primary vehicle registration plate, making it more visible to the public to notice when the vehicle is involved in a process of criminal act. Further, the digital electronic second identity is not easy to be modified or replaced. Moreover, it is also used to enhance safety in the operation of the vehicle as it is activated accordingly to the vehicle acceleration, deceleration, collision, or swerving. Therefore, the digital electronic second identity is also acting as an alert brake light as it is activated upon deceleration.

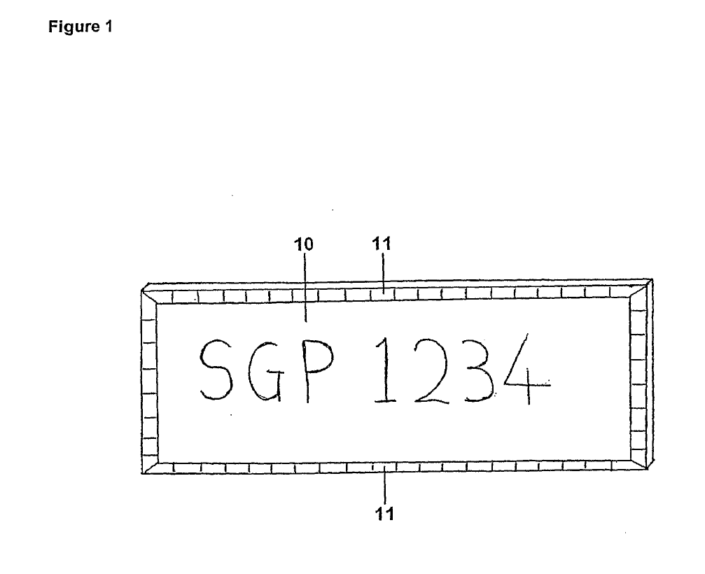

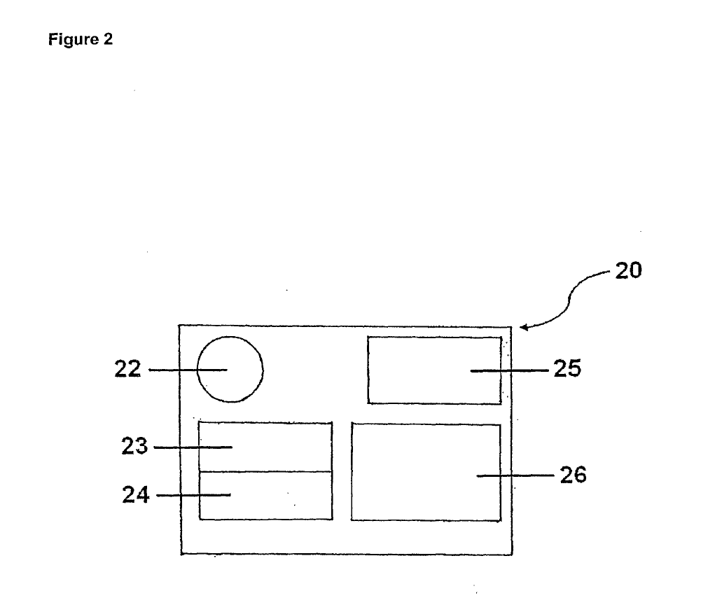

Referring to FIG. 1 and FIG. 2, it illustrates the complete assembly of the digital electronic second identity for vehicle, which comprises a LED display (10), a solar panel (11) located along the front perimeter of said LED display, and a control unit (20) embedded within said digital electronic second identity. The control unit comprises a chipset (25), a sensor (26), a rechargeable battery source (23), a non-rechargeable battery source (24), and a speaker (22).

Referring to FIG. 1, the LED display (10) is connected to and activated by the chipset (25). Upon activation, the LED display (10) will light up, displaying the vehicle registration plate for a stipulated amount of time. The LED display (10) can be attached and used in any portions of the any type of vehicles. Preferably, it is attached to the rear portion of the vehicle at an elevated level. For example, it can be attached to the rear windscreen of a car. In another example, in the case of a motorcycle, it can be attached to the rear of the motorcyclist helmet, tail luggage box or on the back of the rider's jacket. Further, the LED display (10) has the capability to emit high light intensity, which enables the public to notice the displayed information even in bright sunlight. Nonetheless, the LED display (10) needs only a little amount of electric energy to work, and hence it is energy efficient.

Referring now to FIG. 2, the chipset (25) is pre-programmed to contain the specific vehicle registration plate for that particular vehicle. It is connected to the LED display (10) and the sensor (26). When the chipset (25) receives a signal generated by the sensor (26), it will activate the LED display (10) to light up. The chipset (25) has enhanced security that prevents users from manipulating with it. Only an authorize party is allowed to program and alter the information stored in the chipset (25).

Still referring to FIG. 2, the sensor (26) is capable to sense changes in the vehicle motions. It is able to detect acceleration and deceleration of the vehicle. Further, when a collision occurred between the vehicle and any other objects, the sensor (26) is able to detect the impact as well. In addition to those, the sensor (26) is able to detect unstable swerving of the vehicle. Upon detecting those changes in vehicle motion, the sensor (26) will generate an electric signal to the chipset (25), prompting the chipset (26) to trigger the LED display (10). Therefore, the digital electronic second identity is also acting as a secondary break light as it is activated according to deceleration.

Referring now to FIG. 2, the digital electronic second identity is mainly powered by primary and secondary battery sources. In the presence of a vehicle battery such as a car battery, the digital electronic second identity can be powered by said vehicle battery. The primary battery source is a rechargeable battery source (23), whereas the secondary battery source is a non-rechargeable battery source (24). The chemical energy in the rechargeable battery source (23) is supplied by the solar panel (11). Referring back to FIG. 1, the solar panel (11) is located along the front perimeter of the LED display (10), capturing light energy from sun and converting said light energy to electrical energy to be stored in the rechargeable battery source (23). This can be particularly useful since the frequency of battery change can drastically be reduced. The non-rechargeable battery (24) source substitutes the rechargeable battery (23) source to supply power to the digital electronic second identity when the latter is depleted. When the rechargeable (23) and non-rechargeable (24) battery sources are near depletion, the digital electronic second identity will give out a warning beeping sound through the speaker (22). The warning will only cease when either the rechargeable battery source (23) is recharged or the non-rechargeable battery source (24) is replaced with a new one.

The digital electronic second identity for vehicle is meant to be used in harsh conditions. Therefore, it is designed and built to resist shock, vibration and moisture. The casing is weather proofed with an O-ring, sealing out the control unit from moisture.

We claim:

1. A digital electronic second identity for vehicle displaying vehicle registration plate, used to discourage criminal activities and to enhance safety of vehicle operation, comprises:
a LED display (10) for displaying the vehicle registration plate;
a chipset (25) to activate the LED display (10), containing information on the vehicle registration plate pre-programmed by an authorized party;
a sensor (26) connected to the chipset (25), detecting acceleration, deceleration, impact, or swerving of the vehicle;
a rechargeable battery source (23) to supply power to the digital electronic secondary identity;
a solar panel (11) converting light energy to electrical energy to be stored in the rechargeable battery source (23);
a non-rechargeable battery source (24) to substitute the rechargeable battery source (23) to supply power to the digital electronic secondary identity; and
a speaker (22) for producing a beeping sound as a warning when the rechargeable (23) and non-rechargeable battery sources (24) are near depletion;
wherein the chipset (25), sensor (26), rechargeable battery source (23), non-rechargeable battery source (24), and speaker (22) are built inside a control unit (20);
wherein the solar panel (11) is located along the front perimeter of the LED display (10) and connected to the rechargeable battery source (23);
wherein the sensor (26) generates a signal to the chipset (25) upon detection of acceleration, deceleration, impact, or swerving of the vehicle;
wherein the chipset (25) activates the LED display (10) for a stipulated amount of time upon receiving said signal from the sensor (26).

2. A digital electronic second identity in accordance with claim 1, wherein the LED display (10) can be attached to any portions of the vehicle.

3. A digital electronic second identity in accordance with claim 1, wherein the LED display (10) can be attached to the rear of a motorcyclist helmet, tail luggage box, and on the back of the rider's jacket.

4. A digital electronic second identity in accordance with claim 1, wherein the LED display (10) produces high light intensity.

5. A digital electronic second identity in accordance with claim 1, wherein the rechargeable battery source (23) is replaced by the non-rechargeable battery source (24) when said rechargeable battery source (23) is depleted.
